(19) United States
(12) Patent Application Publication
(10) Pub. No.: US 2015/0161192 A1
(43) Pub. Date: Jun. 11, 2015

(54) IDENTIFYING VERSIONS OF AN ASSET THAT MATCH A SEARCH

(71) Applicants: Pascal Scoles, Collegeville, PA (US); Jared Blitzstein, Limerick, PA (US)

(72) Inventors: Pascal Scoles, Collegeville, PA (US); Jared Blitzstein, Limerick, PA (US)

(21) Appl. No.: 14/523,498

(22) Filed: Oct. 24, 2014

Related U.S. Application Data
(60) Provisional application No. 61/912,371, filed on Dec. 5, 2013.

(51) Int. Cl. G06F 17/30

(52) U.S. Cl. CPC G06F 17/30353; G06F 17/30551; G06F 17/30356

(57) ABSTRACT

Systems and methods for identification of one or more versions of an asset that match a search are disclosed herein. A search request that includes a search string is received from a client device. The search request is used to identify an asset maintained by a server that matches the search string included in the search request. The asset may have a plurality of versions, and the search string is compared with the contents of the plurality of versions of the asset. One or more versions of the asset that exceed an overlapping threshold with the search string are determined based on the comparison. A search result is generated based on the determined one or more versions of the asset. Presentation of the generated search result on the client device is caused.

### RELATED APPLICATION

This application claims the priority benefit of U.S. Provisional Patent Application No. 61/912,371, filed Dec. 5, 2013, which is incorporated herein by reference in its entirety.

### TECHNICAL FIELD

The subject matter disclosed herein generally relates to data presentation. Specifically, the present disclosure addresses systems and methods to facilitate identification of one or more versions of an asset that match a search.

### BACKGROUND

A system may manage and store various assets. The system may also track changes to the various assets and store the changes as subsequent versions of the various assets.

### BRIEF DESCRIPTION OF THE DRAWINGS

Some embodiments are illustrated by way of example and not limitation in the figures of the accompanying drawings.

FIG. 1 is a network diagram illustrating a network environment suitable for identification of versions of an asset that match a search, according to some example embodiments.

FIG. 2 is a block diagram illustrating components of a server machine suitable for identification of versions of an asset that match a search, according to some example embodiments.

FIG. 3 is a block diagram that depicts an asset, according to some example embodiments.

FIG. 4 is an example user interface that illustrates a generated search result based on one or more versions of an asset, according to some example embodiments.

FIG. 5-7 are flowcharts illustrating operations of a server machine in performing a method of generating a search result based on one or more identified versions of an asset, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to identification of versions of an asset that match a search. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

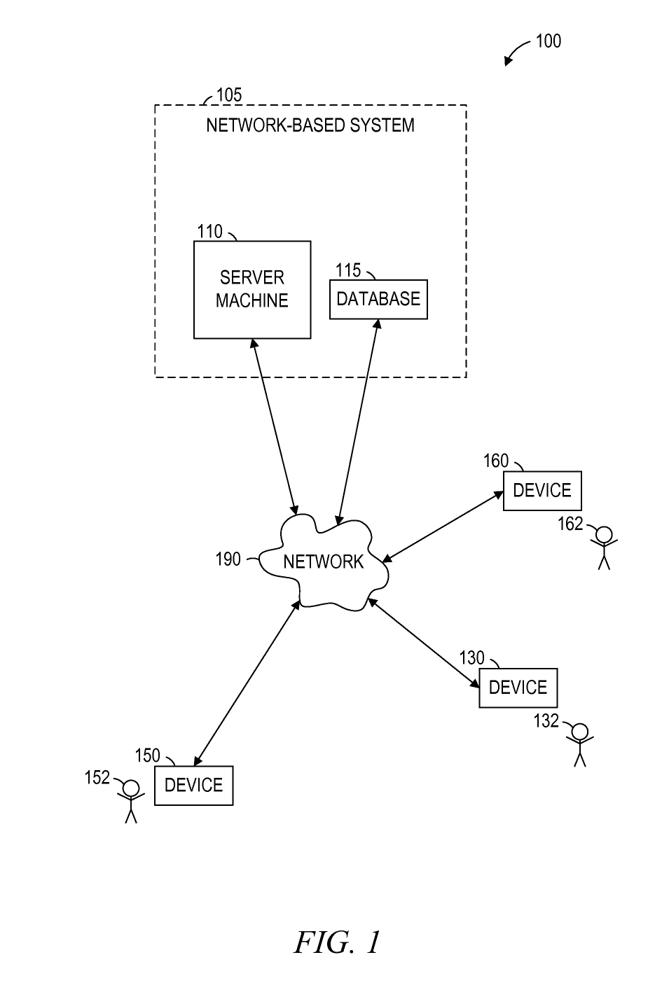

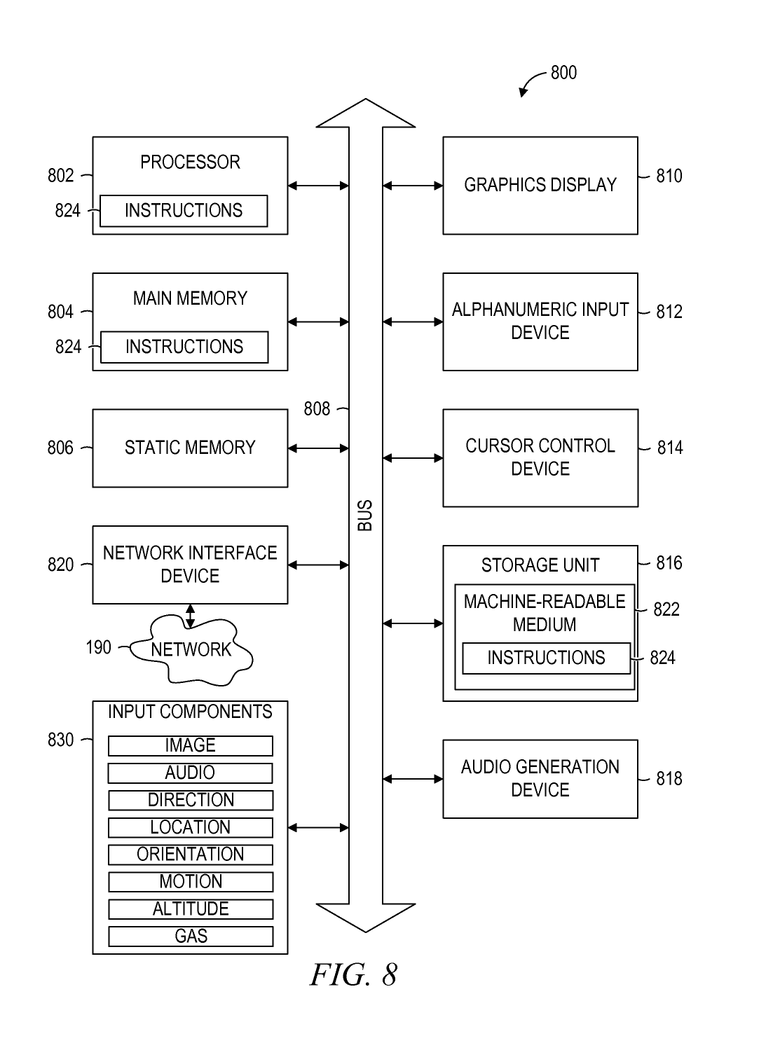

FIG. 1 is a network diagram illustrating a network environment 100 suitable for identification of versions of an asset that match a search, according to some example embodiments. The network environment 100 includes a server machine 110, a database 115, and devices 130, 150, and 160, all communicatively coupled to each other via a network 190. The server machine 110 may form all or part of a network-based system 105 (e.g., a cloud-based server system configured to provide one or more services to the devices 130, 150, and 160). The server machine 110 and the devices 130, 150, and 160 may each be implemented in a computer system, in whole or in part, as described below with respect to FIG. 8.

A search string may be received from a user. The search string may be used to conduct a search for various assets that match with the search string. An asset may be a document that contains alphanumeric characters. Moreover, the asset may have multiple versions.

A server is used to maintain the multiple versions of the asset. Various versions of the asset may be created by the server. In other instances, various versions of the asset may be received independently from sources other than the server. The server may also track changes that occur across each version of the multiple versions of the asset. The server may be used to assist a user in identifying versions of the asset that match the search string. By doing so, the server may reduce a burden on behalf of the user of manually searching through each version of the asset. Further, the server may generate a search result that identifies an earliest version of the asset that matches the search string received from the user. Also, in some cases, the server may assist the user in identifying an outlier or “wild” asset. The outlier asset or “wild” asset may contain a string of alphanumeric characters that is unique to the “wild” asset. Therefore, a search string containing the string of alphanumeric characters unique to the “wild” asset may assist the user in quickly finding the outlier asset. Accordingly, one or more of the methodologies discussed herein may obviate a need for additional searching or navigation by the user, which may have the technical effect of reducing computing resources used by one or more devices within the system. Examples of such computing resources include, without limitation, processor cycles, network traffic, memory usage, storage space, and power consumption.

Also shown in FIG. 1 are users 132, 152, and 162. Each of the users 132, 152, and 162 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152. Further, the user 162 is not part of the network environment 100, but is associated with the device 160. As an example, the device 160 may be a desktop computer, a vehicle computer, a tablet computer, a navigational device, a portable media device, a smartphone, or a wearable device (e.g., a smart watch or smart glasses) belonging to the user 162.

Each of the users 132, 152, and 162 may submit a search string to the server machine 110 using a respective device among the devices 130, 150, and 160. Upon receipt of the search string, the server machine 110 may identify versions of an asset that match with the search string. In some instances, the asset may have multiple versions which are stored in the database 115. Moreover, each of the users 132, 152, and 162 may submit a version of the asset to the server machine 110 which then gets stored in the database 115. Alternatively, the server machine 110 may create or generate a version of the asset which is stored in the database 115.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

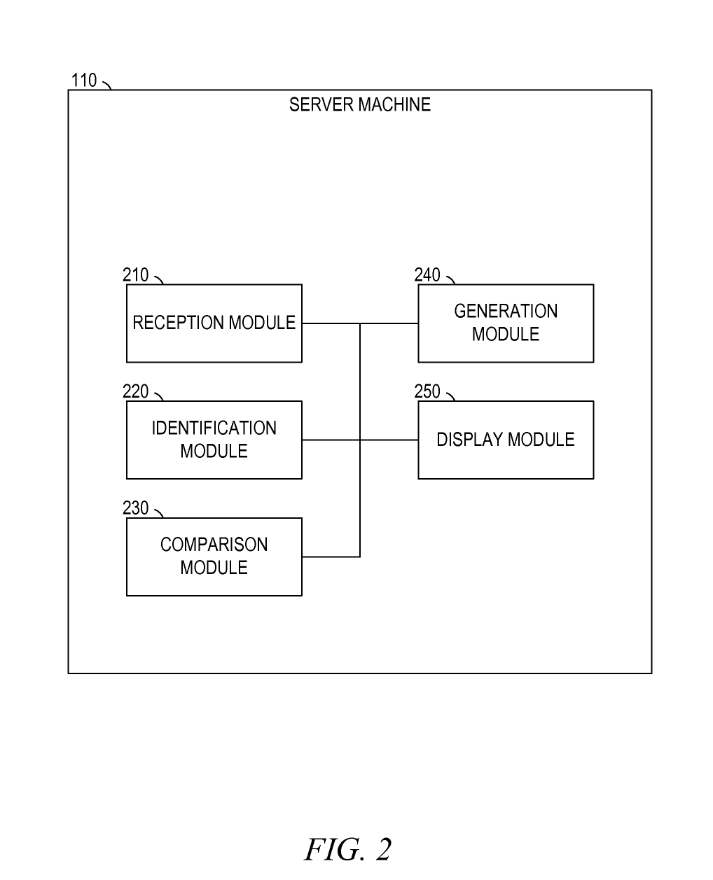

FIG. 2 is a block diagram illustrating components of the server machine 110, according to some example embodiments. The server machine 110 is shown as including a reception module 210, an identification module 220, a comparison module 230, a generation module 240, and a display module 250, all configured to communicate with each other (e.g., via a bus, shared memory, or a switch). Any one or more of the modules described herein may be implemented using hardware (e.g., one or more processors of a machine) or a combination of hardware and software. For example, any module described herein may comprise a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive a search request that includes a search string from a client device. The search string may be represented by a set of alphanumeric characters. The search request may be used to identify one or more versions of an asset maintained by the server machine 110 that match the search string received from the client device. For instance, the asset may be stored within the database 115.

As further explained below, the server machine 110 may track changes to various assets by implementing a version control system. The asset may represent a digital file, such as a document, text file, a piece of software code, and the like. Further, the asset may have a plurality of versions in which each subsequent version of the plurality of versions represents a change with respect to a previous version of the asset.

In various example embodiments, the reception module 210 is further configured to receive a version of the asset from a further client device. In some instances, each of the versions of the asset may be received from a different device. For example, a first user (e.g., user 152) operating a first client device (e.g., device 150) may submit a first version of the asset. Later on, a second user (e.g., user 132) operating a second client device (e.g., 130) may submit a second version of the asset. The second version of the asset may be a modification to the first version of the asset. For example, the second user may download the first version of the asset onto the second client device, perform some modifications to the first version of the asset in order to create the second version of the asset, and then submit the second version of the asset to the reception module 210. The reception module 210 may further store the received second version of the asset in the database (e.g., database 115). Moreover, the second version of the asset may be stored with a timestamp indicating a time of storing.

In various example embodiments, the identification module 220 is configured to identify an asset in response to receipt of the search request. As stated above, the asset may have a plurality of versions. In some instances, the search request may include an identifier of the asset. The identifier of the asset may include a name, an identification number, a link to the asset, and the like. Further, the asset may be identified and retrieved from the database based on the reference to the asset included in the search request. Accordingly, the identification module 220 may be further configured to identify the asset based on the identifier of the asset included in the search request. The asset may be retrieved by the identification module 220 from a database using the identifier of the asset. Alternatively, in some instances, the asset may be identified without having the asset identifier being explicitly provided. Further, the asset may be and retrieved from a database (e.g., database 115) that stores various assets. As an example, the identification module 220 may cycle through the various assets stored in the database until a match with the search string is identified.

In various example embodiments, the comparison module 230 is configured to compare the search string with contents of the plurality of versions of the asset maintained by the server machine 110. The comparison module 230 may be further configured to measure a number of characters that overlap between the search string received from the client device and the contents of the plurality of versions of the asset.

In various example embodiments, the identification module 220 is further configured to identify one or more versions of the asset that match the search string received from the client device. For instance, the identification module 220 determines one or more versions of the asset that exceed an overlapping threshold with the search string. The identification module 220 may be further configured to determine that contents of the one or more versions of the asset have at least a threshold number (e.g., the overlapping threshold) of characters that overlap with the search string. In other words, each of the one or more versions of the asset may have at least the threshold number of characters that overlap with the search string. As an example, the threshold number of characters may define a minimum amount of overlapping characters with the search string that are required in order to be identified by the identification module 220 (e.g., 50 overlapping characters minimum). In some cases, not all of the plurality of versions of the asset will have the threshold number of characters. Therefore, the one or more versions of the asset returned as a search result may be a subset of the plurality of versions of the asset. Further, the overlapping threshold may be predetermined but may also be adjustable.

In one example, the one or more versions of the asset are created or received after a certain date. Therefore, versions of the asset prior to the certain date do not have the threshold number of characters that overlap with the search string.

In another example, a single version of the asset (e.g., “wild” asset) matches the search string received from the other client. The single version of the asset may be an outlier asset. The identification module 220 may identify the “wild” asset and determine that the contents of the “wild” asset have at least a threshold number of characters that overlap with the search string. As such, in this example, the identification module 220 determines that the plurality of versions of the asset other than the “wild” asset do not have at least the threshold number of characters that overlap with the search string.

The threshold number of characters may be represented as a percentage or a value (e.g., 25% overlap). In some instances, the threshold is represented as a portion or a subset of a number of characters in the search string. Further, the threshold is predetermined but may be adjustable and changed by the user.

In various example embodiments, the identification module 220 is further configured to employ predictive algorithms to identify the one or more versions of the asset. In other words, the identification module 220 may identify the one or more versions of the asset based on predictive algorithms that cause the search string to reference the one or more versions of the asset. The predictive algorithms may detect likelihood that the search string is contained in the one or more versions of the asset. Some examples of predictive algorithms may include machine learning algorithms.

In various example embodiments, the identification module 220 is further configured to identify an earliest version of the asset that matches the search string received from the client device. Thus, the identification module 220 determines that the earliest version of the asset is generated or received prior to any remaining versions of the asset from the one or more versions of the asset.

In some instances, the one or more versions of the asset are organized chronologically with the earliest version of the asset being at the beginning or the end of a list. The earliest version of the asset may be used to identify the version of the asset in which the search string first appears. As such, any versions of the asset that are received or generated prior to the identified earliest version of the asset do not contain the search string.

In example embodiments, the generation module 240 is configured to generate a search result based on the identified one or more versions of the asset. The search result may be represented as a page that lists each of the identified one or more versions of the asset.

In example embodiments, the generation module 240 is further configured to determine the identified earliest version of the asset and an identifier for the earliest version of the asset. The generation module 240 may thereafter include the identified earliest version of the asset and the identifier for the earliest version of the asset in the search result. The generation module 240 may also include an indication that visually distinguishes the earliest version of the asset from the one or more versions of the asset in the search result. Therefore, the indication may reference the earliest version of the asset from the one or more versions of the asset in the search result. For instance, the generation module 240 may highlight the earliest version of the asset on the search result page so that it is distinguished from the remaining search results displayed. Moreover, the generation module 240 may be further configured to include the one or more versions of the asset in chronological order in the search result.

In example embodiments, the generation module 240 is further configured to determine information that describes an amount of overlap between the search string and each of the one or more versions of the asset in the search result. Further, the generation module 240 may include the determined information that describes the amount of overlap in the search result. In some cases, the generation module 240 may determine a numerical value that describes an amount of overlap between the search string and a version among the one or more versions of the asset. For instance, the numerical value may represent a percentage of a number of characters of the search string that overlap. Alternatively, the numerical value may be the actual number of characters of the search string that overlap. Other examples may include a graphical image that depicts the amount of overlap between the search string and the one or more versions of the asset.

In various example embodiments, the generation module 240 is further configured to determine asset identifiers that correspond to the one or more versions of the asset. For instance, the generation module 240 may determine version numbers for each of the one or more versions of the asset. Thereafter, the generation module 240 may include the determined asset identifiers in the search result. The generation module 240 may also include timestamps next to each of the one or more versions of the asset in order to signify a date on which a version of the asset was generated or received.

In various example embodiments, the generation module 240 is configured to generate a version of the asset and store it in a database for later retrieval. For instance, the generation module 240 may modify an existing version of the asset to generate a new version of the asset.

In various example embodiments, the display module 250 is configured to cause presentation of the search result on a screen of the client device. In other words, the display module 250 uses the search result generated by the generation module 240 and causes display of the search result on the screen of the client device.

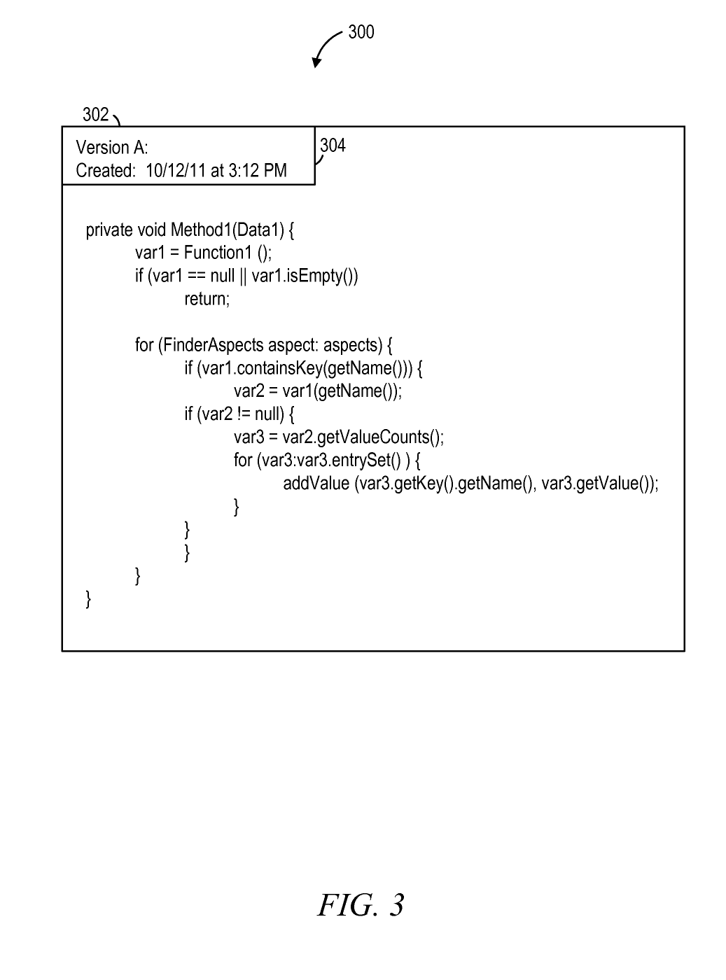

FIG. 3 is a block diagram 300 that depicts an asset 302, according to some example embodiments. As shown, the asset 302 may be a document that includes alphanumeric characters. In this particular case, the asset 302 represents a piece of software code. Moreover, FIG. 3 depicts a particular version of the asset 302, although the asset may have a plurality of versions. The asset 302 may include a description 304 that indicates a version of the asset 302 and a timestamp corresponding to creation of the asset 302. The asset 302 may be stored in the database 115 that is maintained by the server machine 110.

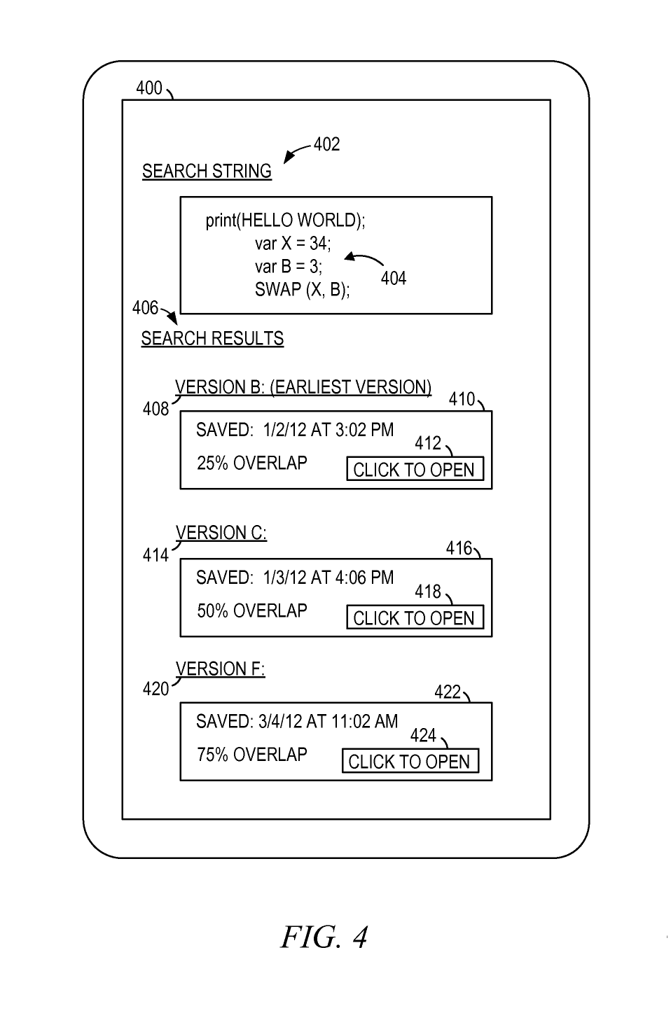

FIG. 4 is an example user interface 400 that illustrates a generated search result based on one or more versions of an asset, according to some example embodiments. The user interface 400 may be displayed on a screen of a client device operated by a user. The user interface 400 may include a search string section 402 that corresponds to where a search string 404 is displayed. The search string 404 may be inputted by the user and may be customized by the user. The user interface 400 may also include a search results section 406. A first version 408, a second version 414, and a third version 420 of the asset is shown in the search results section 406 of the user interface 400. It is noted that any number of versions may be provided in alterative embodiments. Moreover, a first description 410 of the first version 408 of the asset is displayed. The first description 410 contains information that describes an amount of overlap between the first version 408 of the asset and the search string 404. Likewise, a second description 416 is displayed and contains information that describes an amount of overlap between the second version 414 of the asset and the search string 404. Lastly, a third description 422 is displayed and contains information that describes an amount of overlap between the third version 420 of the asset and the search string 404. Also included in each of the first description 410, second description 416, and third description 422 is information that describes when the respective version of the asset was created or received and saved into a database.

Also displayed next to each of the first version 408, second version 414, and third version 420 of the asset is an asset identifier. For instance, the first version 408 is identified as “Version B.” The second version 414 is identified as “Version C.” The third version 420 is identified as “Version F.” Moreover, the first version 408 is also identified as the “Earliest Version” because it chronologically precedes the remaining second version 414 and the third version 420 of the asset. Therefore, the first version 408 is highlighted and distinguished from the remaining versions of the asset. The search results 406 section may display the first version 408, the second version 414, and the third version 420 of the asset because they each have at least a threshold number of characters that match with the search string 404.

Also shown in FIG. 4 are controls 412, 418, and 424 that are each operable to open a corresponding version of the asset. For instance, operation of the control 412 causes the first version 408 of the asset to be displayed. Operation of the control 418 causes the second version 414 of the asset to be displayed. Further, operation of the control 424 causes the third version 420 of the asset to be displayed.

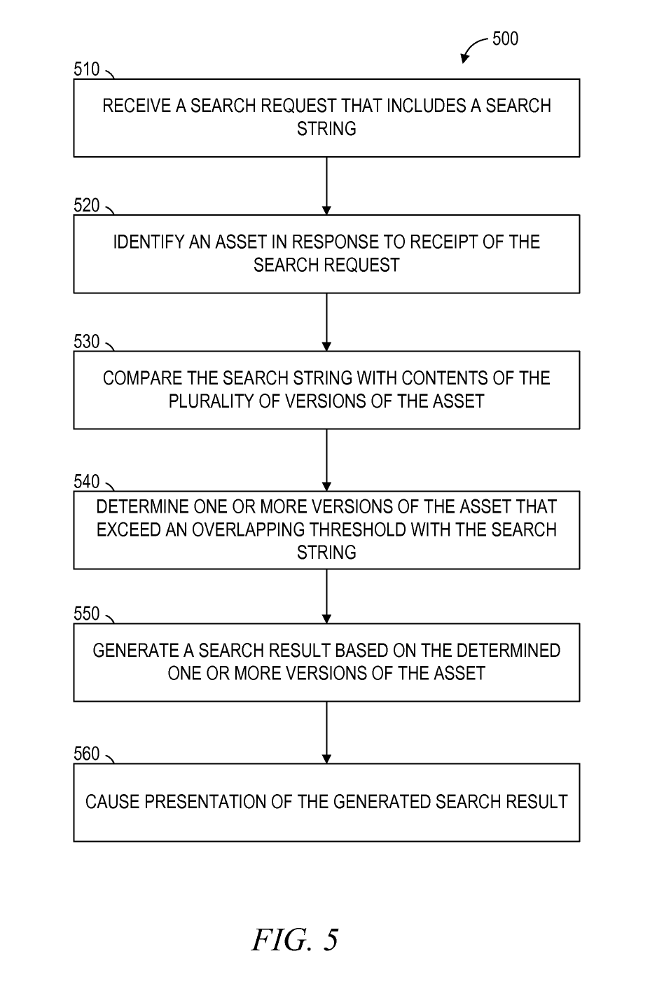

FIG. 5-7 are flowcharts illustrating operations of the server machine 110 in performing a method 500 of generating a search result based on one or more identified versions of an asset, according to some example embodiments. Operations in the method 500 may be performed by the server machine 110, using modules described above with respect to FIG. 2. As shown in FIG. 5, the method 500 includes operations 510, 520, 530, 540, 550, and 560.

At operation 510, the reception module 210 receives a search request that includes a search string received from a client device. The search string may be represented by a set of alphanumeric characters. The search request may be used to identify one or more versions of an asset that match the search string received from the client device. In some instances, the search request also includes an identifier of the asset.

At operation 520, the identification module 220 identifies an asset in response to receipt of the search request. The asset may be retrieved by the identification module 220 from a database that stores various assets. The asset may be retrieved using the identifier of the asset. Alternatively, the asset may be retrieved from the database without using the identifier of the asset (e.g., the identifier of the asset might not be explicitly provided). As stated above, the asset may have a plurality of versions in which each subsequent version of the plurality of versions represents a change with respect to a previous version of the asset.

At operation 530, the comparison module 230 compares the search string with contents of the plurality of versions of the asset. As further explained below, the comparison module 230 compares characters included in the search string with characters included in the contents of the plurality of versions of the asset. The comparison module 230 compares the characters in order to detect an overlap between the characters included in the search string and the characters included in the contents of the plurality of versions of the asset.

At operation 540, the identification module 220 identifies one or more versions of the asset that exceed an overlapping threshold with the search string received from the client device. Therefore, an exact match between the search string and the one or more versions of the asset is not required. In fact, the identification module 220 may determine that the contents of the one or more versions of the asset each have at least a threshold number of characters that overlap with the search string. The threshold may be represented as a portion or subset of a number of characters in the search string. The threshold may be a predetermined threshold that may be further adjusted by a user.

At operation 550, the generation module 240 generates a search result based on the identified one or more versions of the asset that has at least a threshold number of characters that overlap. The search result may be represented as a page that lists each of the identified one or more versions of the asset. As further explained below, the search result page may also indicate an earliest version of the asset among the one or more versions of the asset that match the search request.

At operation 560, the display module 250 causes presentation of the generated search result on a screen of the client device. In one embodiment, the display module 250 provides the search results to the client device, and the client device presents the search result as a user interface.

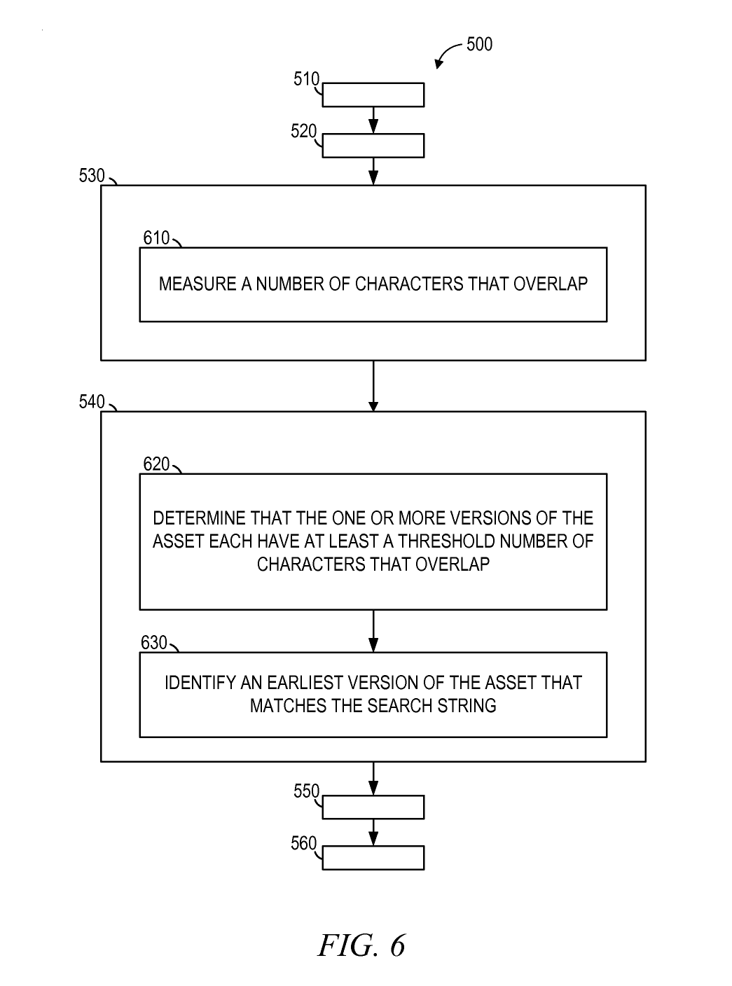

As shown in FIG. 6, the method 500 may include one or more of operations 610, 620, and 630. At operation 610, the comparison module 230 measures a number of characters that overlap between the search string received from the client device and the contents of the plurality of versions of the asset. The operation 610 may be performed as part of the operation 530 of FIG. 5.

At operation 620, the identification module 220 determines that the one or more versions of the asset each have at least a threshold number of characters that overlap with the search string. The operation 620 may be performed by the identification module 220 as part of the operation 540 of FIG. 5.

At operation 630, the identification module 220 identifies, from the one or more versions of the asset, an earliest version of the asset that matches the search string received from the client device. The operation 630 may be performed by the identification module 220 as part of the operation 540 of FIG. 5. In some cases, if the one or more versions of the asset are numerous and cannot all be displayed as part of the search results page, the identification module 220 may select a subset of the one or more versions of the asset (e.g., select a subset of the one or more versions that are chronologically first or select a subset of the one or more versions that have a greatest amount of overlapping characters with the search string).

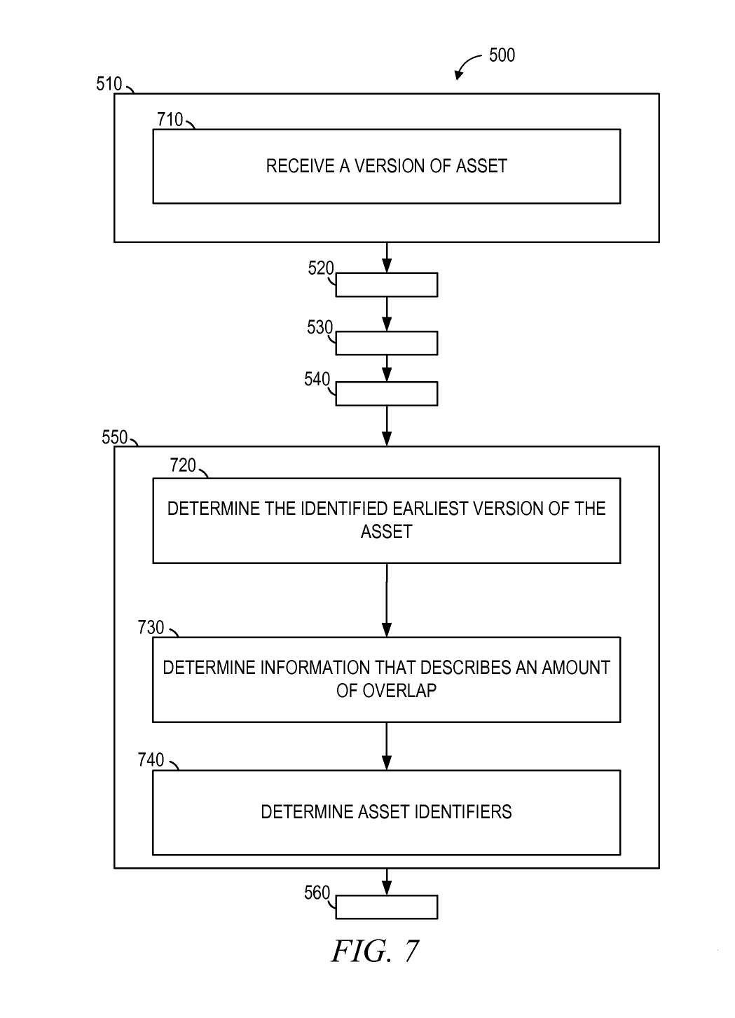

As shown in FIG. 7, the method 500 may include one or more of operations 710, 720, 730, and 740. At operation 710, the reception module 210 receives a version of the asset from a further client device prior to receiving the search string. For example, each of the versions of the asset may be received from separate devices. The reception module 210 receives a first version of the asset from a first user. Subsequently, the reception module 210 may receive a second version of the asset from a second user or any other user including the first user. The operation 710 may be performed by the reception module 210 prior to the operation 510 of FIG. 5. The versions received in operation 710 are saved to the database and include information regarding when the versions are received or saved (e.g., a timestamp indicating a time of storing).

At operation 720, the generation module 240 determines the earliest version of the asset that matches the search string received from the client device. For instance, the generation module 240 may distinguish the earliest version of the asset from the remaining assets in the generated search result based on a timestamp. The operation 720 may be performed by the generation module 240 as part of the operation 550 of FIG. 5.

At operation 730, the generation module 240 determines an amount of overlap between the search string and each of the one or more versions of the asset. The information may be a numerical value that describes an amount of overlap between the search string and a version among the one or more versions of the asset. The numerical value may represent a percentage of a number of characters that overlap. Alternatively, the numerical value may be the actual number of characters that overlap. Other examples may include a graphical image that depicts the amount of overlap between the search string and the one or more versions of the asset. The operation 720 may be performed by the generation module 240 as part of the operation 550 of FIG. 5.

At operation 740, the generation module 240 determines asset identifiers that correspond to the one or more versions of the asset. The asset identifiers may be version numbers for each of the one or more versions of the asset. Alternatively, the asset identifiers may also include timestamps for each of the one or more versions of the asset. The timestamps may be used to indicate a date when an asset among the one or more versions of the asset was generated or received. The operation 730 may be performed by the generation module 240 as part of the operation 550 of FIG. 5.

When these effects are considered in aggregate, one or more of the methodologies described herein may obviate a need for certain efforts or resources that otherwise would be involved in identifying versions of an asset that match a search. Efforts expended by a user in the identification of the versions of the asset may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 8 is a block diagram illustrating components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include any collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, an audio generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered machine-readable media (e.g., tangible and non-transitory machine-readable media). The instructions 824 may be transmitted or received over the network 190 via the network interface device 820. For example, the network interface device 820 may communicate the instructions 824 using any one or more transfer protocols (e.g., hypertext transfer protocol (HTTP)).

In some example embodiments, the machine 800 may be a portable computing device, such as a smart phone or tablet computer, and have one or more additional input components 830 (e.g., sensors or gauges). Examples of such input components 830 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. As used herein, the term “or” may be construed in either an inclusive or exclusive sense.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a search request that includes a search string from a client device, the search request used to identify an asset maintained by a server that matches the search string received from the client device;
identifying the asset in response to receipt of the search request that includes the search string, the asset having a plurality of versions;
comparing the search string with contents of the plurality of versions of the asset maintained by the server;
based on the comparison, determining, by one or more processors, one or more versions of the asset that exceed an overlapping threshold with the search string received from the client device;
generating a search result based on the determined one or more versions of the asset; and
causing presentation of the generated search result on the client device.

2. The method of claim 1, wherein the comparing the search string with the contents of the plurality of versions of the asset includes measuring a number of characters that overlap between the search string received from the client device and the contents of the plurality of versions of the asset.

3. The method of claim 1, wherein the determining the one or more versions of the asset includes determining that the one or more versions of the asset each have at least a threshold number of characters that overlap with the search string.

4. The method of claim 1, further comprising:
identifying, from the one or more versions of the asset, an earliest version of the asset that matches the search string received from the client device.

5. The method of claim 4, wherein the generating the search result includes including an indication that references the earliest version of the asset from the one or more versions of the asset in the search result.

6. The method of claim 1, wherein the generating the search result includes including the one or more versions of the asset in chronological order in the search result.

7. The method of claim 1, wherein the generating the search result includes including information that describes an amount of overlap between the search string and each of the one or more versions of the asset.

8. The method of claim 1, wherein the generating the search result includes including asset identifiers that correspond to the one or more versions of the asset.

9. The method of claim 1, further comprising:
prior to receiving the search string, receiving a version of the asset from a further client device; and
storing the version of the asset with a timestamp indicating a time of storing.

10. The method of claim 1, further comprising:
prior to receiving the search string, generating a version of the asset; and
storing the generated version of the asset in a database.

11. A system comprising:
a reception module configured to receive a search request that includes a search string from a client device, the search request used to identify an asset maintained by a server that matches the search string received from the client device;
an identification module configured to identify the asset in response to receipt of the search request that includes the search string, the asset having a plurality of versions;
a comparison module comprising at least one processor and configured to compare the search string with contents of the plurality of versions of the asset maintained by the server, the identification module being further configured to, based on the comparison, determine one or more versions of the asset that exceed an overlapping threshold with the search string received from the client device;
a generation module configured to generate a search result based on the determined one or more versions of the asset; and
a display module configured to cause presentation of the generated search result on the client device.

12. The system of claim 11, wherein the comparison module is further configured to measure a number of characters that overlap between the search string received from the client device and the contents of the plurality of versions of the asset.

13. The system of claim 11, wherein the identification module is further configured to determine that the one or more versions of the asset each have at least a threshold number of characters that overlap with the search string.

14. The system of claim 11, wherein the identification module is further configured to identify, from the one or more versions of the asset, an earliest version of the asset that matches the search string received from the client device.

15. The system of claim 14, wherein the generation module is further configured to include an indication that references the earliest version of the asset from the one or more versions of the asset in the search result.

16. The system of claim 11, wherein the generation module is further configured to include the one or more versions of the asset in chronological order in the search result.

17. The system of claim 11, wherein the generation module is further configured to include information that describes an amount of overlap between the search string and each of the one or more versions of the asset.

18. The system of claim 11, wherein the generation module is further configured to include asset identifiers that correspond to the one or more versions of the asset.

19. The system of claim 11, wherein the reception module is further configured to receive a version of the asset from a further client device prior to receiving the search string.

20. A non-transitory machine-readable medium storing instructions that, when executed by one or more processors of a machine, cause the machine to perform operations comprising:
receiving a search request that includes a search string from a client device, the search request used to identify an asset maintained by a server that matches the search string received from the client device;
identifying the asset in response to receipt of the search request that includes the search string, the asset having a plurality of versions;
comparing the search string with contents of the plurality of versions of the asset maintained by the server;
based on the comparison, determining one or more versions of the asset that exceed an overlapping threshold with the search string received from the client device;
generating a search result based on the determined one or more versions of the asset; and
causing presentation of the generated search result on the client device.
